(19) United States
(12) Patent Application Publication
(10) Pub. No.: US 2008/0315679 A1
(43) Pub. Date: Dec. 25, 2008

(54) STEEL INSERT FOR ALUMINUM SPLINE BODY

(76) Inventor: William B. Shook, Tampa, FL (US)

Correspondence Address: ROSENBERG, KLEIN & LEE, 3458 ELLICOTT CENTER DRIVE-SUITE 101, ELLICOTT CITY, MD, 21043, US

(21) Appl. No.: 12/141,483

(22) Filed: Jun. 18, 2008

Related U.S. Application Data
(60) Provisional application No. 60/936,302, filed on Jun. 19, 2007.

(51) Int. Cl. B60B 27/00

(52) U.S. Cl. 301/110.5

(57) ABSTRACT

A steel insert for transferring load to an aluminum splined body from thin plate like sprockets used in multiple speed bicycle drive systems is held in place by a dovetail tongue. The tongue is fitted into a mating groove in the aluminum spline and together the steel insert and the aluminum spline are the proper width to fit the industry standard spline. The dovetail in the tongue of the insert holds the insert securely in position while handling the aluminum splined body, installing or uninstalling sprockets. Drive load from the sprocket is handled as a compressive load on the insert and the aluminum spline but does not load the tongue. The steel insert prevents the thin teeth of the sprocket from damaging the aluminum body or aluminum spline.

### FIELD OF THE INVENTION

The present invention relates to a multiple speed sprocket drive system for bicycles, and more particularly, to an insert fitted to a spine on the drive body of a bicycle hub to transfer torque to the drive wheel.

### BACKGROUND OF THE INVENTION

The current tread is to use a splined drive body on the rear hub to accept the multiple drive sprockets. In recent years, the number of the sprockets has been increasing and the thickness of each sprocket has decreased in order to fit the sprockets in to the limited space available. High performance bicycles strive to be light weight as light weight increases their performance. The splined drive body on which the sprockets are mounted have been made of steel for ordinary hubs and aluminum alloy on high performance hubs.

A conventional derailleur system for multiple speed bicycle is shown in FIGS. 5 to 7 and generally includes a plurality of sprockets 90 mounted to the drive body 60 of a rear wheel hub 61 so as to transfer torque to the rear wheel (not shown) to allow the bicycle to move at different speeds. The drive body 60 is a tubular portion and has a plurality of splines 70 on the outer surface of the drive body 60 in axial direction so as to define multiple grooves 71 between the splines 70. Each of the sprockets 90 has a mounting hole and splines are formed on an inner periphery of the mounting hole so as to be engaged with the grooves 71 of the drive body 60.

The thinner sprockets 90 are cutting into and damaging the softer aluminum splines 70 of the light weight high performance hubs 61. The steel drive body splines work without damage, but it is heavy and thus lower performance compared to the aluminum drive body.

The present invention intends to provide a steel insert which is fitted with the aluminum spline on the drive body so as to avoid from damage to the softer spline by high contact loads of the thin sprockets.

### SUMMARY OF THE INVENTION

The present invention relates to a drive body for a bicycle hub and the drive body includes at least one spline on an outer surface of the drive body of the hub and at least one insert made of harder material is attached on the outer surface of the drive body of the hub and engaged with the at least one spline. The at least one insert has an outer surface which is shaped to overlap with an outer surface of the at least one spline.

The primary object of the present invention is to provide a steel insert which solves the problem of the soft aluminum splines being damaged by the high contact loads of the thin mating spline of the sprockets.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the drive body of a hub and the steel insert of the present invention;

FIG. 2 is an end view to show that the steel inserts of the present invention are installed to the driving body and the steel inserts are shaped to overlap the curvature of the splines on the drive body of the hub;

FIG. 3 shows that each tongue of the steel insert has two doventail sides;

FIG. 4 is a perspective view to show sprockets are mounted to the drive body with the steel inserts;

FIG. 5 shows sprockets are to be mounted to the drive body of a conventional hub;

FIG. 6 is a sectional view to show that one sprocket is mounted to the drive body of the conventional hub, and

FIG. 7 shows a partial cross sectional view of the conventional drive body of the hub.

### DETAILED DESCRIPTION OF THE PREFERRED EMBODIMENT

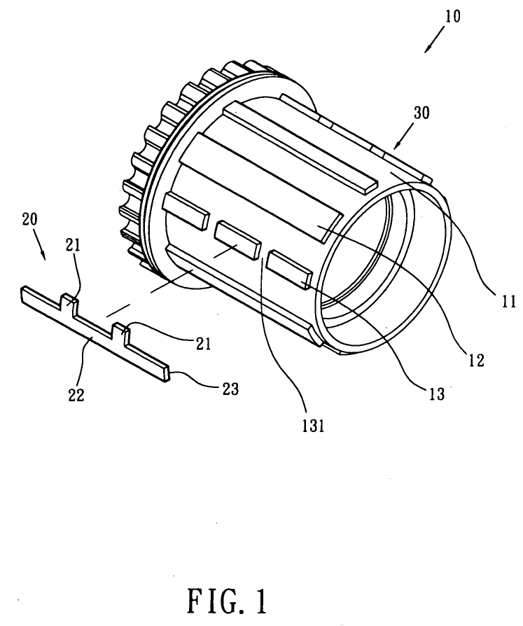

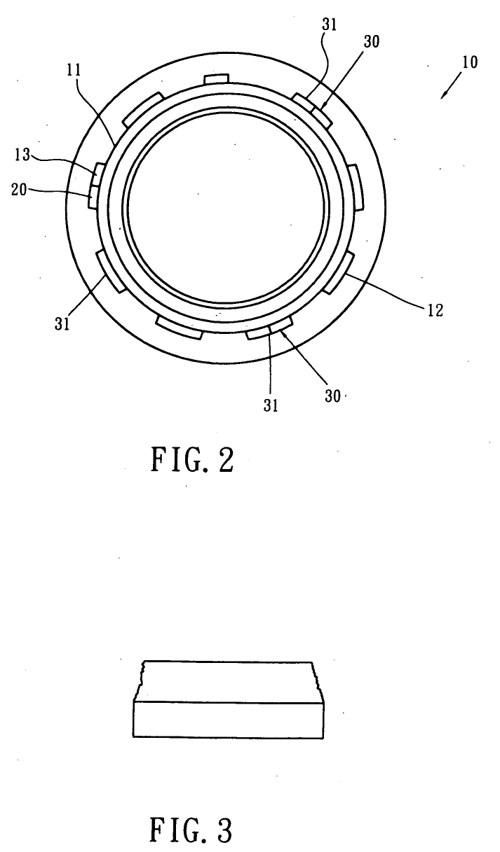

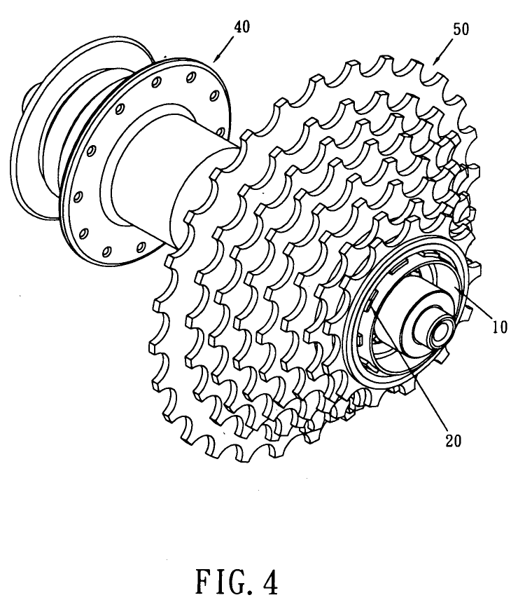

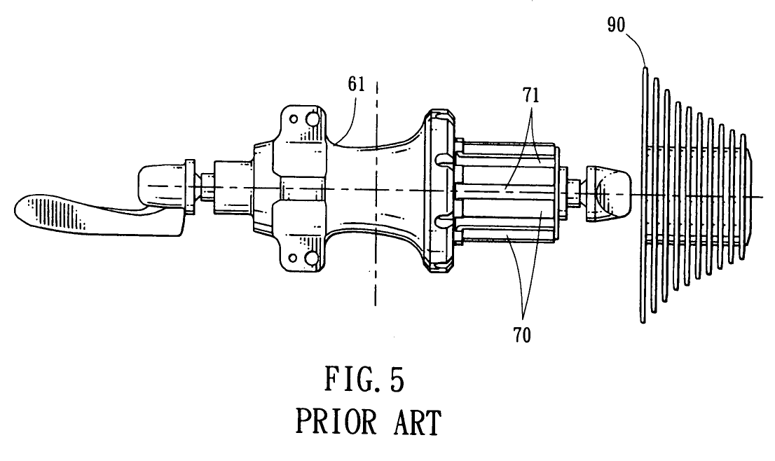

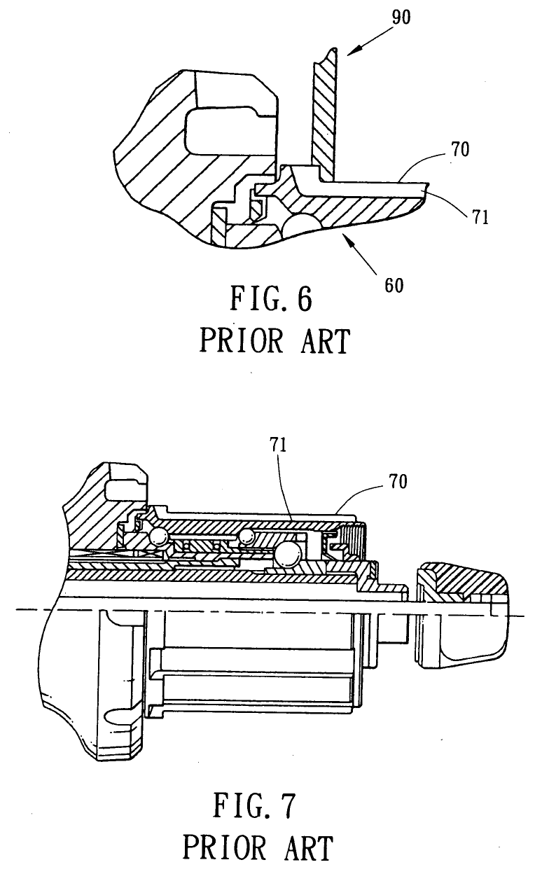

Referring to FIGS. 1 to 4, the drive body 10 for a bicycle hub 40 is a tubular body and comprises a plurality of splines 12 and 13 on an outer surface 11 of the drive body 10 of the hub 40. The splines 12, 13 extend axially on the outer surface 11 of the drive body 10. The splines 12 each have a first width and the splines 13 each have a second width which is narrower than the first width. Grooves are defined between the splines 12, 13 so as to receive splines of the sprockets 50 when mounting the sprockets 50 onto the drive body 10. In this embodiment, the splines 13 each are composed of three sections and mating grooves 131 are defined between the sections. The mating grooves 131 each are defined by dovetailed insides.

A plurality of inserts 20 made of harder material such as steel are attached on the outer surface 11 of the drive body 10 of the hub 40. Each insert 20 includes two tongues 21 extending therefrom and each of the tongues 21 includes two dovetailed sides which are matted with the corresponding dovetailed insides of the mating grooves 131. The engagement of the two dovetailed sides of each of tongues 21 and the dovetailed insides of the mating grooves 131 securely hold the steel insert 20 with the sections of the spline 13.

The steel inserts 20 each includes an inner surface 23 and an outer surface 22, wherein the inner surface 23 is shaped to match with a curvature of the outer surface 11 of the drive body 10 of the hub 40 and the outer surface 22 is shaped to overlap with an outer surface of the splines, 12 and 13. The combined splines 13 and the steel inserts 20 form splines 30 that has the same width as the first width of the splines 12 and the curvature of the outer surface 31 of each of the splines 30 is the same as that of the splines 12. It is to be understood that there can be other methods to accomplish the same result. For example, one skilled in the art could use other methods to form a taper in the tongue 21 and could form the aluminum alloy to hold onto the tongues 21. Also the shape of the tongue can vary. The tongues 21 can be bent and pressed into a hole in the drive body.

By this way, the sprockets 50 can be mounted to the drive body 10 as the conventional assembly way and the steel inserts 20 of the present invention provide solid support when transferring high contact loads and torques from the sprockets 50 of multiple gear bicycle hub. The steel inserts 20 are cooperated with the aluminum splines 12, 13 so as to keep the derailleur system to be light in weight while high loads and torques can be transferred.

While we have shown and described the embodiment in accordance with the present invention, it should be clear to those skilled in the art that further embodiments may be made without departing from the scope of the present invention.

What is claimed is:

1. A drive body (10) for a bicycle hub (40) comprising:
at least one spline (13) on an outer surface (11) of the drive body (10) of the hub (40), and
at least one insert (20) made of harder material attached on the outer surface (11) of the drive body (10) of the hub (40) and engaged with the at least one spline (13), the at least one insert (20) having an outer surface which is shaped to overlap with an outer surface of the at least one spline (13).

2. The drive body as claimed in claim 1, wherein the at least one insert (20) includes at last one tongue (21) extending therefrom and the at least one spline (13) has at least one mating groove (131) with which the at least one tongue (21) is engaged such that the at least one insert (20) is positioned on the drive body (10) of the hub (40).

3. The drive body as claimed in claim 2, wherein the at least one tongue (21) includes two dovetailed sides which are matted with corresponding dovetailed insides of the at least one mating groove (131).

4. The drive body as claimed in claim 1, wherein the at least one insert (20 includes an inner surface (23 which is shaped to match with a curvature of the outer surface (11 of the drive body (10 of the hub (40.
